(19) United States
(12) Patent Application Publication
(10) Pub. No.: US 2022/0406156 A1
(43) Pub. Date: Dec. 22, 2022

(54) SECURITY TAG

(71) Applicant: Sekura Global IP LLP, Colchester (GB)

(72) Inventor: Russell NAPTHINE, Colchester (GB)

(73) Assignee: Sekura Global IP LLP, Colchester (GB)

(21) Appl. No.: 17/755,456

(22) PCT Filed: Oct. 30, 2020
(86) PCT No.: PCT/GB2020/052739

§ 371 Date: Apr. 29, 2022

(30) Foreign Application Priority Data
Nov. 1, 2019 (GB) 1915942.5

(51) Int. Cl. G08B 13/24; E05B 73/00

(52) U.S. Cl. CPC G08B 13/2434; E05B 73/0017

(57) ABSTRACT

This invention relates to security tags for use in a retail environment. In particular, this invention relates to security tags that may be attached to an item and may be used to suspend or hang the item in a retail display. A security tag for attachment to an object comprises a main body including an electronic article surveillance (EAS) sensor and a first aperture; a retainer including a second aperture, the retainer being connected to the main body and being moveable between a first position and a second position relative to the main body; and a securing mechanism comprising a first part provided on the main body and a second part provided on the retainer. In the first position the securing mechanism is not engaged and an object is insertable between the main body and the retainer, and in the second position the securing mechanism is engaged to retain the retainer in the second position and the first aperture is aligned with the second aperture. The EAS sensor is configured to be deactivated.

### FIELD OF THE INVENTION

This invention relates to security tags for use in a retail environment. In particular, this invention relates to security tags that may be attached to an item and may be used to suspend or hang the item in a retail display.

### BACKGROUND TO THE INVENTION

There are a number of known systems for deterring or preventing theft of articles from a retail environment. Typically these systems include an electronic article surveillance (EAS) tag that is attached to the article or object in a retail store. While the EAS tag is activated, the tag is arranged to trigger an alarm if the tag, and therefore the article, passes between a pair of detection gates, which are typically positioned at the entrance and exit of the retail store.

One known EAS tag is commonly referred to as a hard tag and includes an acousto-magnetic sensor in a hard, or semi-rigid, plastic body. Such hard tags are typically physically or mechanically attached to an article by means of a pin, cable or lanyard. When the article is purchased, the tag is detached from the article by a detacher located at the point of sale so that the alarm is not triggered when that person leaves the retail store. Hard tags that are deactivated and removed completely from the article are re-usable.

A disadvantage of traditional hard tags is that they have to be removed by store associates which has sometimes caused delays at the checkout. Additionally, the store assistants are spending time applying and removing tags from items when that time is better spent providing customer service. Furthermore, time and space must be given to the storage and recycling of the tags.

An advantage of hard tags, however, is their ability to act as a deterrent. Some prior art hard tags also provide further utility within a retail setting, for example, as a packaging closure or as a way of supporting or mounting an item in a retail display. A hard tag may, for example, include a hole that may be used to hang the item to which the tag is attached.

Recently there has been an increase in the use of self-service checkouts in retail stores. A disadvantage of the present systems is that there is a need for an assistant to deactivate and/or remove any security tags that are attached to items being purchased. It would be desirable if a customer could deactivate the security tag at the point of sale without requiring assistance.

Furthermore, it would be desirable to provide a security tag that could be removed by the customer at home after purchase of the item. This would mean that store assistants were no longer spending time removing tags at checkouts.

### SUMMARY OF THE INVENTION

According to a first aspect of the present invention there is provided a security tag for attachment to an object, the security tag comprising:
a main body including an electronic article surveillance (EAS) sensor and a first aperture;
a retainer including a second aperture, the retainer being connected to the main body and being moveable between a first position and a second position relative to the main body;
a securing mechanism comprising a first part provided on the main body and a second part provided on the retainer,
wherein, in the first position the first and second parts of the securing mechanism are not engaged and an object is insertable between the main body and the retainer, and in the second position first and second parts of the securing mechanism are engaged and the first aperture is aligned with the second aperture, and engagement of the first and second parts of the securing mechanism retains the retainer in the second position, and
wherein the EAS sensor is capable of deactivation.

The present invention therefore provides a security tag that may be secured to an object to provide an EAS sensor that will trigger detectors at an exit of a retail space, and provides a hanging aperture that allows the object to be suspended from a retail display. The EAS sensor is configured to be deactivated, for example at a point of sale. In this way the security tag does not need to be removed from the object in the retail store, but can be disposed of by the consumer.

Preferably the retainer is connected to the main body by an elongate connecting member. In preferred embodiments the retainer is connected to the main body by a flexible strap. This allows the retainer to be moved from the first position to the second position, and permits a part of the object to be located between the retainer and the main body when the retainer is in the second position. In this regard, in the second position there is preferably a gap between a part of the retainer and a part of the main body. In use, at least a part of the object is disposed in the gap between the retainer and the main body.

In preferred embodiments one of the first and second parts of the securing mechanism comprises a hole and the other one of the first and second parts of the securing mechanism comprises a post insertable into the hole. Preferably a latch member extends into the hole and is configured to engage with the post.

The securing mechanism may be single use, such that after engagement of the first and second parts of the securing mechanism the first and second parts of the securing mechanism cannot be disengaged without breaking or disabling at least one of the first and second parts of the securing mechanism. In this way the first and second parts of the securing mechanism cannot be re-engaged to retain the retainer in the second position.

In preferred embodiments the main body comprises a plate member having opposite first and second faces. Preferably the retainer comprises a plate member having opposite first and second faces. When the retainer is in the second position the first face of the retainer preferably faces and opposes a part of the first face of the main body.

In some embodiments the plate member of the main body and the plate member of the retainer are made of a suitable polymeric material. The polymeric material is preferably a substantially rigid polymeric material. In embodiments in which a connecting member connects the retainer to the main body, the connecting member may connect the plate member of the main body to the plate member of the retainer. In these embodiments the plate member of the main body, the plate member of the retainer and the connecting member may be a unitary moulding.

In some embodiments the security tag may further comprise a post that at least partially extends between the retainer and the main body when the retainer is in the second position.

A length of the retainer is preferably less than a length of the main body and a width of the retainer is preferably less than a width of the main body. In this way, the dimensions of the retainer are smaller than the dimensions of the main body. When the security tag is attached to an object, such as an item of packaging, it may be desirable to secure the security tag to the object such that the retainer is in contact with a front surface of the object. The smaller dimensions of the retainer means that a smaller area of the front surface of the object is obscured by the security tag. This may be beneficial when the object is in a retail display.

Preferably the first and second apertures are the same size and shape. The apertures may be circular or may have the shape of a Euro slot.

In some embodiments the EAS sensor is affixed to a first surface of the main body.

According to a second aspect of the present invention there is provided an assembly comprising:
an object; and
a security tag according to the first aspect of the invention, the security tag secured to the object with the retainer in the second position such that the aligned first and second apertures are in a region of the security tag that protrudes from an edge of the object.

Preferably the object is an item of packaging.

In preferred embodiments the object includes a hole and a part of the securing mechanism or a post of the security tag extends through the hole in the object.

The object may include a first side and a second side, and the retainer is preferably in contact with the first side and the main body of the security tag is in contact with the second side.

According to a third aspect of the present invention there is provided a method of attaching a security tag to an object, the security tag comprising a main body and a retainer connected to the main body, and the method comprising:
placing the main body of the security tag against a part of the object with the retainer in a first position, the main body including an electronic article surveillance (EAS) sensor capable of deactivation and a first aperture;
moving the retainer into a second position with respect to the main body such that a part of the object is disposed between the main body and the retainer and a second aperture in the retainer is aligned with the first aperture of the main body; and
engaging a first part of a securing mechanism provided on the main body with a second part of the securing mechanism provided on the retainer to retain the retainer in the second position and secure the security tag to the object, with a part of the object disposed between the retainer and the main body.

In preferred embodiments the object includes a hole and the method preferably comprises inserting a part of the securing mechanism or a post of the security tag through the hole in the object.

### BRIEF DESCRIPTION OF THE DRAWINGS

The invention will now be further described by way of example only and with reference to the accompanying drawings, in which:

FIG. 1 shows a security tag in accordance with a first preferred embodiment of the present invention;

FIG. 2 is a plan view of the security tag of FIG. 1;

FIG. 3 is a further view of the security tag of FIG. 1;

FIG. 4 is a plan view from a first side of a security tag in accordance with a second preferred embodiment of the present invention;

FIG. 5 is a plan view from a second side of the security tag of FIG. 4;

FIG. 6 is a side view of the security tag of FIG. 4;

FIG. 7 shows a security tag according to the present invention together with an item of packaging;

FIG. 8 shows the security tag of FIG. 7 partially engaged with the item of packaging; and

FIG. 9 shows the security tag of FIG. 7 fully engaged with and secured to the item of packaging.

### DESCRIPTION OF THE PREFERRED EMBODIMENTS

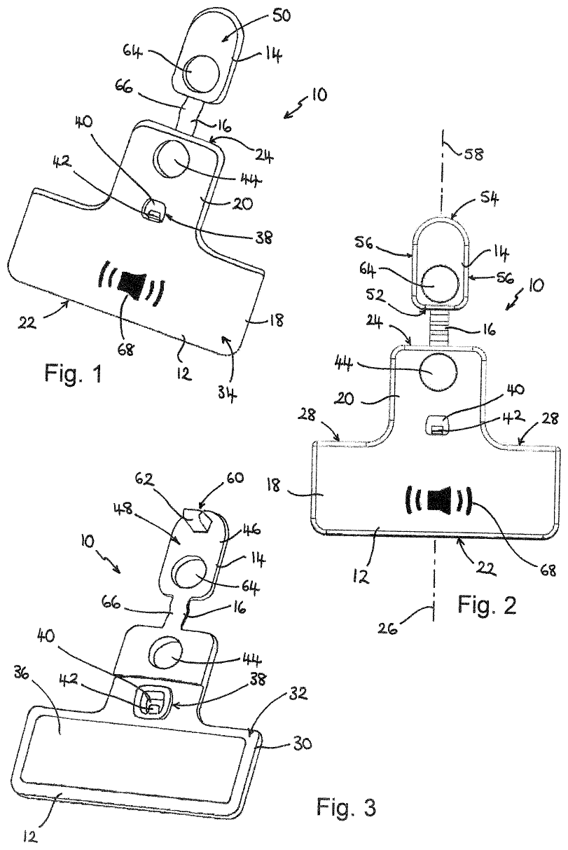

A security tag 10 according to a first embodiment of the invention is shown in FIGS. 1 to 3. The security tag 10 is configured to be secured to an item of packaging or other object for display in a retail environment. The security tag 10 comprises a securing mechanism that engages with and secures the security tag 10 to the item. The security tag 10 further comprises an aperture that enables the security tag to be suspended from a suitable hanging member that, in use, extends through the aperture. In this way, after the security tag 10 has been attached to an item, the item can then be suspended or hung by the security tag 10 from a suitable peg or hook in a retail display.

In this embodiment the security tag 10 comprises a main body 12 and a retainer 14. The retainer 14 is connected to the main body 12 by a connecting member 16. The connecting member 16 is configured such that the retainer 14 can be moved between a first position and a second position relative to the main body 12.

The main body 12 is substantially T-shaped and includes a sensor portion 18 and an attachment portion 20. The attachment portion 20 extends from the sensor portion 18 such that a first end edge 22 of the sensor portion 18 forms a first end edge 22 of the main body 12 and an end edge 24 of the attachment portion 20 forms a second end edge 24 of the main body 12. A longitudinal axis 26 of the main body 12 extends between the first and second end edges 22, 24, and a distance between the first and second end edges 22, 24 defines a length of the main body 12. In this embodiment a width of the sensor portion 18, perpendicular to the longitudinal axis 26, is greater than a width of the attachment portion 20, and the attachment portion 20 extends from a central region of the sensor portion 18. As such, the sensor portion 18 further comprises a second end edge 28, with a first part of the second end edge 28 being disposed on a first side of the attachment portion 20 and a second part of the second end edge 28 being disposed on a second side of the attachment portion 20.

The main body 12 is preferably in the form of a plate member 30, such that a thickness of the main body 12 is substantially less than a width or length of the main body 12. The main body 12 therefore includes a first face 32 and an opposite second face 34.

It will be appreciated that in other embodiments of the security tag the main body may have any suitable shape. The main body may, for example, be substantially square, rectangular or triangular.

The sensor portion 18 of the main body 12 includes an electronic article surveillance (EAS) sensor 36. The EAS sensor 36 may be of any suitable type. For example the EAS sensor 36 may be an electromagnetic (EM) sensor, an acousto-magnetic (AM) sensor or a radio frequency (RF) sensor. The EAS sensor 36 is preferably configured to be activated and deactivated, i.e. capable of activation and deactivation.

The EAS sensor 36 generates detectable signals that, in use, are detected by a suitable EAS detector typically located at the exit of the retail store. If an article with an activated security tag 10 is removed from the store and, therefore, passes the detector, the detector detects the signals emitted by the EAS sensor 36 and triggers an alarm.

The EAS sensor 36 may be in the form of an EAS label 36 attached to a plate member 30 of the main body 12. In this embodiment the EAS label 36 is secured to the first face 32 of the plate member 30 of the main body 12.

The attachment portion 20 of the main body 12 comprises a first part of the securing mechanism 38. In this embodiment the first part of the securing mechanism 38 comprises a through hole 40 and a latch member 42. In this embodiment the latch member 42 projects in a radial direction into the hole 40.

The attachment portion 20 of the main body 12 further comprises an aperture 44.

The aperture 44 is disposed in an end region of the attachment portion 20 proximate the end edge 24. In this embodiment, therefore, the first part of the securing mechanism 38 is disposed between the sensor portion 18 and the aperture 44. In this embodiment the aperture 44 is circular. In other embodiments the aperture 44 may be of any suitable shape and dimensions. For example, the aperture 44 may be substantially triangular or may have the shape of a Euro slot (which may also be referred to as an inverted T, a sombrero or a butterfly hang hole).

The retainer 14 of this embodiment comprises a plate member 46 having a first face 48 and an opposite second face 50. The retainer 14 further comprises a first end edge 52, a second end edge 54 and two side edges 56. A longitudinal axis 58 of the retainer 14 extends between the first and second end edges 52, 54, and a distance between the first and second end edges 52, 54 defines a length of the retainer 14. A width of the retainer 14, defined as the distance between the side edges 56, is preferably substantially the same as or less than the width of the attachment portion 20 of the main body 12.

In this embodiment the second end edge 54 of the retainer 14 has a convex curved profile. The second end edge 54 is preferably substantially semi-circular.

The retainer 14 comprises a second part of the securing mechanism 60. In this embodiment the second part of the securing mechanism 60 comprises a projection or post 62. In this embodiment the post 62 projects substantially perpendicularly from the first face 48 of the retainer 14. The post 62 is configured to engage with the first part of the securing mechanism 38 provided in the main body 12. In this embodiment the post 62 is configured to at least partially extend through the hole 40 in the main body 12 and a part of the post 62 is configured to engage with the latch member 42, as described further below. The post 62 may, therefore, include a hook portion or barb.

The retainer 14 further comprises an aperture 64. In this embodiment the aperture 64 is circular. In other embodiments the aperture 64 may be of any suitable shape and dimensions. For example, the aperture 64 may be substantially triangular or may have the shape of a Euro slot. The shape and dimensions of the aperture 64 of the retainer 14 are preferably the same as the shape and dimensions of the aperture 44 of the main body 12.

In this embodiment the aperture 64 is disposed in an end region of the retainer 14 proximate the first end edge 52 of the retainer 14. The second part of the securing mechanism 60 is disposed between the aperture 64 and the second end edge 54 of the retainer 14.

The connecting member 16 extends between the end edge 24 of the attachment portion 20 of the main body 12 and the first end edge 52 of the retainer 14. The connecting member 16 connects the retainer 14 to the main body 12.

The connecting member 16 is in the form of a flexible strap 66. The flexible strap 66 permits the retainer 14 to move between the first and second positions.

In the first position the first and second parts of the securing mechanism 38, 60 are not engaged. In the first position, therefore, there is a gap between the retainer 14 and the main body 12 such that an item can be located between the retainer 14 and the main body 12. In particular, in the first position there is a gap between the first part of the securing mechanism 38 and the second part of the securing mechanism 60.

In the second position the first and second parts of the securing mechanism 38, 60 are engaged. In particular, in this embodiment, in the second position, the post 62 of the second part of the securing mechanism 60 is located in the through hole 40 of the first part of the securing mechanism 38 and the post 62 is engaged with the latch member 42. Engagement of the latch member 42 with the post 62 retains the post 62 in the through hole 40 and therefore retains the retainer 14 in the second position.

The post 62 of the second part of the securing mechanism 60 is designed to be inserted through a hole or aperture in an item, such as an item of packaging, before being engaged with the first part of the securing mechanism 38. In this way, when the retainer 14 is in the second position the security tag 10 is secured or attached to the item.

In this embodiment, when the retainer 14 is in the second position the first face 48 of the retainer 14 faces towards the first face 32 of the main body 12.

In preferred embodiments the engagement of the latch member 42 with the post 62 is such that the post 62 cannot be withdrawn from the through hole 40 without breaking or disabling at least one of the post 62 and the latch member 42. In these embodiments therefore the securing mechanism is single use.

In the second position the aperture 64 of the retainer 14 is aligned with the aperture 44 of the main body 12.

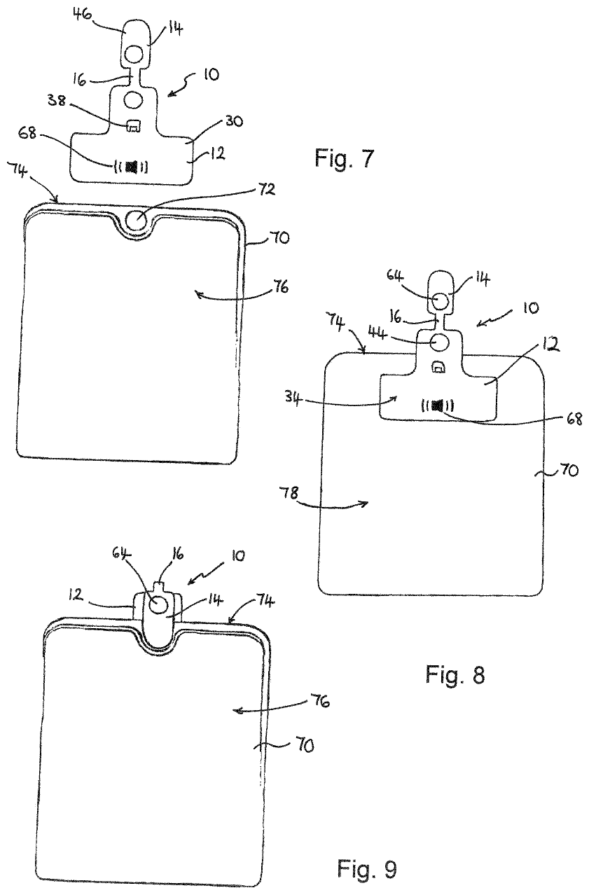

The attachment of the security tag 10 to an item will now be described with particular reference to FIGS. 7 to 9.

In this example the security tag 10 is being attached to an item of packaging 70 which is in the form of a blister pack 70. The blister pack 70 will include an interior volume for containing an object. Once the object has been purchased the blister pack 70 will be opened to remove the object from the packaging and the blister pack 70 will be disposed of.

The security tag 10 of the present invention is designed to be disposed of together with the packaging 70. The security tag preferably comprises a suitable plastics material. In preferred embodiments the plate member 46 of the retainer 14, the plate member 30 of the main body 12 and the connecting member 16 is a unitary, single-piece moulding to which an EAS sensor 36 is attached. The security tag 10 may be manufactured, for example by injection moulding, to keep the manufacturing costs to a minimum.

The blister pack 70 includes a hole 72 proximate an edge 74 of the blister pack 70. Typically the hole 72 will be proximate an upper edge 74 of the blister pack 70 such that the blister pack 70 may be suspended by the hole 72 from a suitable peg or hook in a retail display. The hole 72 extends fully through the blister pack 70 from a first side 76 of the blister pack 70 to an opposite second side 78 of the blister pack 70. Typically the first side 76 of the blister pack 70 will be a front side and the second side 78 will be a rear side of the blister pack 70. It will be appreciated that when the blister pack 70 is in a retail display the front side 76 of the blister pack 70 preferably faces towards a consumer. The front side 76 of the blister pack 70 will therefore include typically include branding and/or other imagery, and may include a clear window, such that the goods within the blister pack 70 can be viewed by the consumer.

To attach the security tag 10 to the blister pack 70 the main body 12 of the security tag 10 is preferably placed against the second side 78 of the blister pack 70, as illustrated in FIG. 8. The main body 12 is positioned such that the first part of the securing mechanism 38 is aligned with the hole 72 in the blister pack 70. The main body 12 of the security tag 10 is placed against the blister pack 70 with the retainer 14 in the first position.

The retainer 14 is then moved from the first position to the second position. During this movement the projection or post 62 of the second part of the securing mechanism 60 is inserted through the hole 72 in the blister pack 70 and is engaged with the first part of the securing mechanism 38.

As described above, the latch member 42 of the first part of the securing mechanism 38 engages with the post 62 to retain the post 62 in the through hole 40. The retainer 14 is therefore retained in the second position with the post 62 extending through the hole 72 in the blister pack 70, such that the security tag 10 is attached to the blister pack 70. With the security tag 10 attached in this way, the first faces 32, 48 of each of the main body 12 and the retainer 14 faces towards the blister pack 70. Because, in this embodiment, the EAS label 36 is attached to the first face 32 of the main body 12, the EAS label 36 is disposed between the plate member 30 of the main body 12 of the tag 10 and the blister pack 70. The EAS label 36 is therefore hidden from view.

In some embodiments it may, therefore, be desirable to provide markings 68 on the second face 34 of the main body 12 of the security tag 10 that alert a consumer to the provision of an EAS sensor 36 in the security tag 10. These markings 68 may be in the form of words, symbols or other characters.

With the retainer 14 in the second position the first aperture 44 of the main body 12 is aligned with the second aperture 64 of the retainer 14. The position of the first and second parts of the securing mechanism 38, 60 is such that when the security tag 10 is attached to the blister pack 70 the end regions of the retainer 14 and the main body 12 extend or project beyond the edge 74 of the blister pack 70. The first and second apertures 44, 64, in these end regions, are therefore disposed beyond the edge 74 of the blister pack 70. The first and second apertures 44, 64 may then be used to suspend the blister pack 70 from a suitable peg or hook in a retail display.

It will be appreciated that the dimensions of the retainer 14 (for example the length and width of the retainer 14) are such that the retainer 14 obscures as little of the first side 76 of the blister pack 70 (i.e. the front of the packaging) as possible.

When a consumer purchases the item, the security tag 10 is deactivated, so that the security tag is able to pass the EAS detectors at the exit of the retail store without triggering the alarm. The EAS sensor 36 of the security tag 10 is preferably deactivated by passing the security tag 10 over a suitable deactivator at the checkout of the retail store. Once the EAS sensor 36 has been deactivated, the consumer is able to take the item that has been purchased, with the security tag 10 still attached, out of the retail store. The consumer can then remove and dispose of the security tag 10 together with the packaging 70 at their convenience.

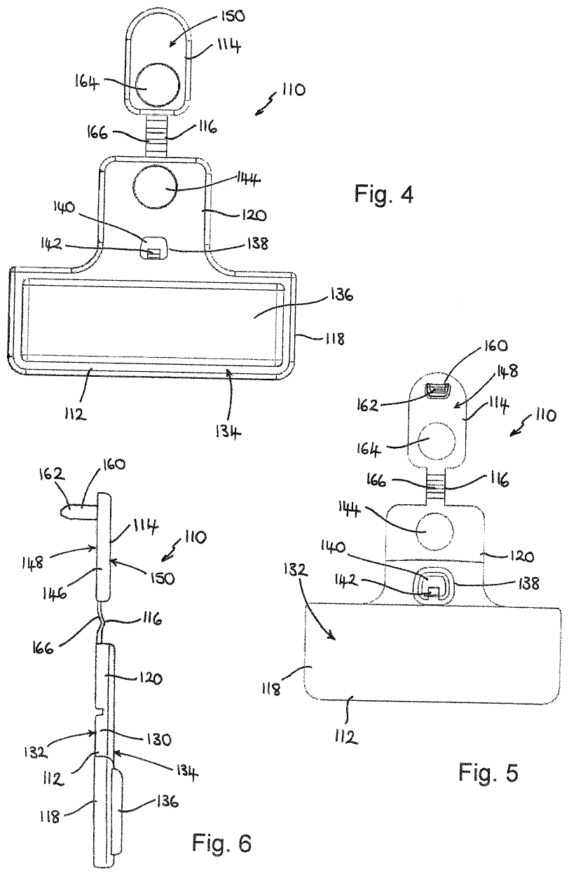

A security tag 110 according to a second embodiment of the invention is shown in FIGS. 4 to 6. The security tag 110 of this embodiment is substantially the same as the security tag 10 of the first embodiment, and like features have been indicated by reference numerals incremented by 100.

In this embodiment the security tag 110 comprises a main body 112 and a retainer 114, and the retainer 114 is connected to the main body 112 by a connecting member 116. The connecting member 116 is configured such that the retainer 114 can be moved between a first position and a second position relative to the main body 112.

The main body 112 includes a sensor portion 118 and an attachment portion 120. The main body 112 is in the form of a plate member 130 and includes a first face 132 and an opposite second face 134. In this embodiment an EAS label 136 is secured to the second face 134 of the plate member 130 of the main body 112, in the sensor portion 118 of the main body 112.

The attachment portion 120 of the main body 112 comprises a first part of the securing mechanism 138. In this embodiment the first part of the securing mechanism 138 comprises a through hole 140 and a latch member 142. The attachment portion 120 of the main body 120 further comprises an aperture 144.

The retainer 114 of this embodiment comprises a plate member 146 having a first face 148 and an opposite second face 150. The retainer 114 further comprises a second part of the securing mechanism 160. In this embodiment the second part of the securing mechanism 160 comprises a projection or post 162. In this embodiment the post 162 projects substantially perpendicularly from the first face 148 of the retainer 114. The post 162 is configured to engage with the first part of the securing mechanism 138 provided on the main body 112. In this embodiment the post 162 is configured to at least partially extend through the hole 140 in the main body 112 and a part of the post 162 is configured to engage with the latch member 142, as described above in relation to the first embodiment.

The retainer 114 further comprises an aperture 164.

The connecting member 116 extends between an edge of the attachment portion 120 of the main body 112 and an edge of the retainer 114. The connecting member 116 connects the retainer 114 to the main body 112. The connecting member 116 is in the form of a flexible strap 166, and permits the retainer 114 to move between the first and second positions.

In the first position the first and second parts of the securing mechanism 138, 160 are not engaged. In the first position, therefore, there is a gap between the retainer 114 and the main body 112 such that an item can be located between the retainer 114 and the main body 112. In particular, in the first position there is a gap between the first part of the securing mechanism 138 and the second part of the securing mechanism 160.

In the second position the first and second parts of the securing mechanism 138, 160 are engaged. In particular, in this embodiment, in the second position, the projection 162 of the second part of the securing mechanism 160 is located in the through hole 140 of the first part of the securing mechanism 138 and the projection 162 is engaged with the latch member 142. Engagement of the latch member 142 with the projection 162 retains the projection 162 in the through hole 142 and therefore retains the retainer 114 in the second position.

The projection 162 of the second part of the securing mechanism 160 is designed to be inserted through a hole or aperture in an item, such as an item of packaging, before being engaged with the first part of the securing mechanism 138. In this way, when the retainer 114 is in the second position the security tag 110 is secured or attached to the item.

The security tag 110 preferably comprises a suitable plastics material. In preferred embodiments the plate member 146 of the retainer 114, the plate member 130 of the main body 112 and the connecting member 116 is a unitary, single-piece moulding to which an EAS sensor 136 is attached.

In preferred embodiments the engagement of the latch member 142 with the projection 162 is such that the projection 162 cannot be withdrawn from the through hole 140 without breaking or disabling at least one of the projection 162 and the latch member 142. In these embodiments therefore the securing mechanism is single use.

In this embodiment, when the retainer 114 is in the second position the first face 148 of the retainer 114 faces towards the first face 132 of the main body 112.

To attach the security tag 110 to an item of packaging (for example a blister pack) the main body 112 of the security tag 110 is preferably placed against a second, rear side of the packaging. The main body 112 of the tag 110 is positioned such that the first part of the securing mechanism 138 is aligned with a hole in the packaging. The main body 112 of the security tag 110 is placed against the packaging with the retainer 114 in the first position.

The retainer 114 is then moved from the first position to the second position. During this movement the projection 162 of the second part of the securing mechanism 160 is inserted through the hole in the packaging and is engaged with the first part of the securing mechanism 138.

In the second position the aperture 164 of the retainer 114 is aligned with the aperture 144 of the main body 112. The position of the first and second parts of the securing mechanism 138, 160 relative to the apertures 144, 164 is such that when the security tag 110 is attached to the item of packaging the end regions of the retainer 114 and the main body 112 extend or project beyond an edge of the packaging. The first and second apertures 144, 164, in these end regions, are therefore disposed beyond the edge of the packaging. The first and second apertures 144, 164 may then be used to suspend the item of packaging from a suitable peg or hook in a retail display.

With the security tag 110 attached in this way, the first face 132, 148 of each of the main body 112 and the retainer 114 faces towards the item of packaging. Because, in this embodiment, the EAS label 136 is attached to the second face 134 of the main body 112, the EAS label 136 is disposed on an outwardly facing surface of the security tag 110 such that the EAS label 136 is clearly visible to a consumer.

In the above embodiments the first part of the securing mechanism comprised a through-hole. In other embodiments the first part of the securing mechanism may comprise a blind hole or a recess, into which the second part of the securing mechanism is inserted.

Furthermore, in the above embodiments the main body included the first part of the securing mechanism and the retainer included the second part of the securing mechanism. It will be appreciated that in other embodiments the main body may include the second part of the securing mechanism and the retainer may include the first part of the securing mechanism.

In yet further embodiments the first and second parts of the securing mechanism may be of any suitable shape and configuration such that one of the first and second parts is engageable with the other of the first and second parts to retain the retainer in the second position with respect to the main body of the security tag.

In some embodiments the security tag may include a projection or post that extends through a hole in an tern of packaging when the security tag is attached to that item of packaging. That projection or post may be separate from and independent of the securing mechanism.

In some embodiments, when the retainer is in the first position, the plate member of the main body may lie in substantially the same plane as the plate member of the retainer, and the longitudinal axis of the main body may be substantially parallel to and aligned with the longitudinal axis of the retainer. In these embodiments, the retainer may move through an angle of nearly 180° between the first position and the second position. In the second position the longitudinal axis of the main body may be substantially parallel to but offset from the longitudinal axis of the retainer.

It will be appreciated that further variations and modifications not explicitly described above are also possible, without departing from the scope of the invention as defined in the appended claims.

1. A security tag for attachment to an object, the security tag comprising:
a main body including an electronic article surveillance (EAS) sensor and a first aperture;
a retainer including a second aperture, the retainer being connected to the main body and being moveable between a first position and a second position relative to the main body;
a securing mechanism comprising a first part provided on the main body and a second part provided on the retainer,
wherein, in the first position the first and second parts of the securing mechanism are not engaged and an object is insertable between the main body and the retainer, and in the second position first and second parts of the securing mechanism are engaged and the first aperture is aligned with the second aperture, and engagement of the first and second parts of the securing mechanism retains the retainer in the second position, and
wherein the EAS sensor is capable of deactivation.

2. The security tag of claim 1, wherein the retainer is connected to the main body by an elongate connecting member.

3. The security tag of claim 1, wherein the retainer is connected to the main body by a flexible strap.

4. The security tag of claim 1, wherein in the second position there is a gap between a part of the retainer and a part of the main body.

5. The security of claim 1, wherein one of the first and second parts of the securing mechanism comprises a hole and the other one of the first and second parts of the securing mechanism comprises a post insertable into the hole.

6. The security tag of claim 5, wherein a latch member extends into the hole and is configured to engage with the post.

7. The security tag of claim 1, wherein the main body comprises a plate member having opposite first and second faces.

8. The security tag of claim 1, wherein the retainer comprises a plate member having opposite first and second faces.

9. The security tag of claim 1, in which the main body comprises a plate member having opposite first and second faces and the retainer comprises a plate member having opposite first and second faces, and wherein when the retainer is in the second position the first face of the retainer faces and opposes a part of the first face of the main body.

10. The security tag of claim 1, wherein the securing mechanism is single use, such that after engagement of the first and second parts of the securing mechanism the first and second parts of the securing mechanism cannot be disengaged without breaking or disabling at least one of the first and second parts of the securing mechanism such that the first and second parts of the securing mechanism cannot be re-engaged to retain the retainer in the second position.

11. The security tag of claim 1, further comprising a post that at least partially extends between the retainer and the main body when the retainer is in the second position.

12. The security tag of claim 1, wherein a length of the retainer is less than a length of the main body and a width of the retainer is less than a width of the main body.

13. The security tag of claim 1, wherein the first and second apertures are the same size and shape.

14. The security tag of claim 1, wherein the EAS sensor is affixed to a first surface of the main body.

15. An assembly comprising:
an object; and
a security tag according to claim 1, the security tag secured to the object with the retainer in the second position such that the aligned first and second apertures are in a region of the security tag that protrudes from an edge of the object.

16. The assembly of claim 15, wherein the object is an item of packaging.

17. The assembly of claim 15, wherein the object includes a hole and a part of the securing mechanism or a post of the security tag extends through the hole in the object.

18. The assembly of claim 15, wherein the object includes a first side and a second side, and the retainer is in contact with the first side and the main body of the security tag is in contact with the second side.

19. A method of attaching a security tag to an object, the security tag comprising a main body and a retainer connected to the main body, and the method comprising:
placing the main body of the security tag against a part of the object with the retainer in a first position, the main body including an electronic article surveillance (EAS) sensor capable of deactivation and a first aperture;
moving the retainer into a second position with respect to the main body such that a part of the object is disposed between the main body and the retainer and a second aperture in the retainer is aligned with the first aperture of the main body; and
engaging a first part of a securing mechanism provided on the main body with a second part of the securing mechanism provided on the retainer to retain the retainer in the second position and secure the security tag to the object, with a part of the object disposed between the retainer and the main body.

20. The method of claim 19, wherein the object includes a hole and the method comprises inserting a part of the securing mechanism or a post of the security tag through the hole in the object.
